(19) United States
(12) Patent Application Publication
(10) Pub. No.: US 2013/0111337 A1
(43) Pub. Date: May 2, 2013

(54) ONE-CLICK MAKEOVER

(71) Applicant: ArcSoft Inc., Fremont, CA (US)

(72) Inventors: Hui Deng, San Ramon, CA (US); Jianfeng Li, Hangzhou (CN); Jin Wang, Hangzhou (CN); Wanjiang Wang, Hangzhou (CN); Wei Zhou, Hangzhou (CN)

(73) Assignee: ArcSoft Inc., Fremont, CA (US)

(21) Appl. No.: 13/664,402

(22) Filed: Oct. 30, 2012

Related U.S. Application Data
(60) Provisional application No. 61/554,968, filed on Nov. 2, 2011.

(51) Int. Cl. G06K 9/46; G06F 17/00

(52) U.S. Cl. 715/255; 382/202

(57) ABSTRACT

A method for a makeover application executed by a processor includes, when a cloud face analyzer is accessible over a compute network, transmitting an image with a face to the cloud face analyzer over the computer network. The cloud face analyzer detects the face and facial feature points of the face, and returns this information to the makeover application. When the cloud face analyzer is not accessible over the computer network, the method includes using a local face analyzer to detect the face and the facial feature points. The method further includes applying an effect to the face in the image based on the facial feature points, displaying the image, and saving the image.

### CROSS-REFERENCE TO RELATED APPLICATION

This application claims the benefit of U.S. Provisional Application No. 61/554,968, filed Nov. 2, 2011.

### BACKGROUND

Everyone is frustrated when an otherwise great photograph is compromised by one or more persons being captured unfavorably. Thus, what is needed is an easy-to-use solution to improve a photograph when less than all the faces are optimal.

### BRIEF DESCRIPTION OF THE DRAWINGS

In the drawings:

FIG. 1 is a block diagram of a system with a computing device having a makeover application and a server computer having a cloud face analyzer;

FIG. 2 is a flowchart of a method for the system in FIG. 1 to improve a portrait image; and

FIGS. 3, 4, 5, 6, 7, and 8 are screenshots of a graphic user interface of the makeover application, all arranged according to embodiments of the present disclosure.

Use of the same reference numbers in different figures indicates similar or identical elements.

### DETAILED DESCRIPTION

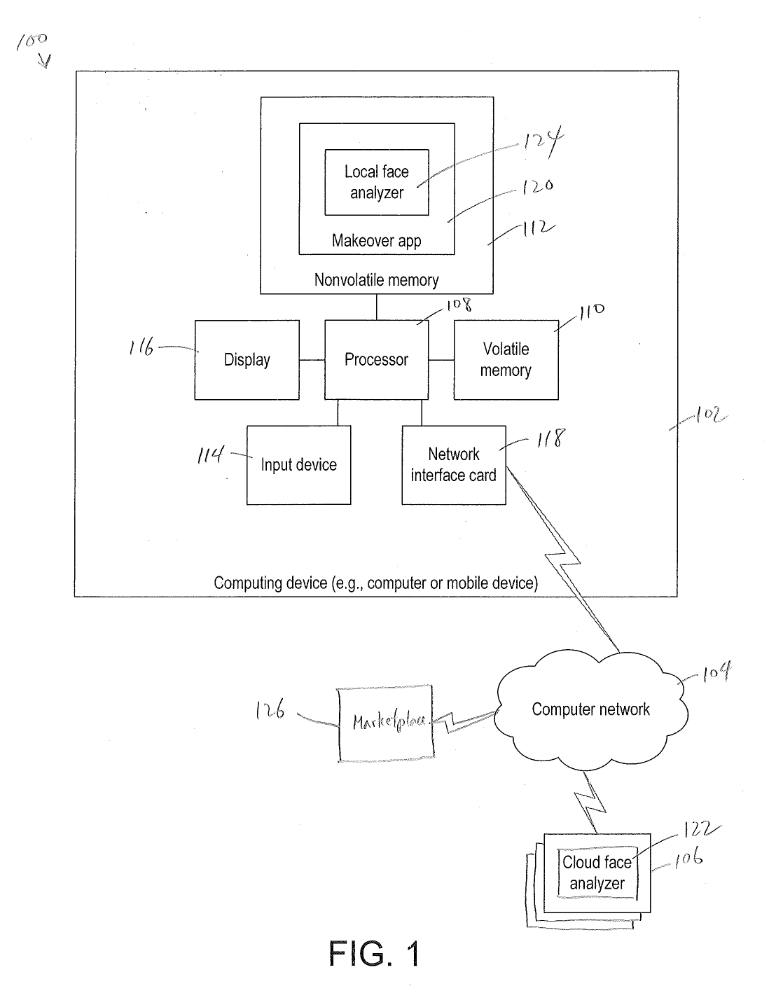

FIG. 1 is a block diagram of a system 100 with a computing device 102 connected by a computer network 104 (e.g., the Internet) to one or more server computers (hereafter “cloud server”) 106 in one or more embodiments of the present disclosure. Computing device 102 may be a computer, a smart television, a setup box, or a mobile device, such as a smart phone or a tablet computer. Computing device 102 includes a processor 108, a volatile memory 110, a nonvolatile memory 112, an input device 114, a display 116, and a wired or wireless network interface card (NIC) 118. Processor 108 loads the code of a makeover application 120 from nonvolatile memory 112 to volatile memory 110, executes the code, and stores application data in the volatile memory. Processor 108 receives user input via input device 114, outputs results on display 116, and communicates with cloud server 106 using NIC 118. Input device 114 may be a mouse, a touchpad, or a touchscreen.

Makeover application 120 may transmit a portrait image over computer network 104 to a cloud face analyzer 122 on cloud server 106. The portrait image may include one or more faces. Cloud face analyzer 122 detects the one or more faces in the portrait image. For each face, cloud face analyzer 122 automatically (without user input) determines rough outlines of facial features, points of the facial features (“facial feature points”), age, gender, and race, and transmits this information back to makeover application 120. The detected facial features include cheeks, mouth, eyes, eye brows, nose, irises, pupils, teeth, lips, and T-zone (an area including the nose and across the forehead).

Cloud face analyzer 122 is trained with a large database of positive and negative samples. The user may manually fine-tune the locations of the facial feature points on makeover application 120, which are transmitted back to cloud face analyzer 122. The cloud face analyzer 122 may utilize user's adjustments of the facial feature points as additional training and learning experience.

When cloud face analyzer 122 cannot be reached, makeover application 120 uses a local face analyzer 124 to determine rough outlines of facial features, facial feature points, age, gender, and race. Cloud face analyzer 122 may be a simplified version of cloud face analyzer 122.

Makeover application 120 provides one or more graphical user interfaces (GUIs) for the user to select a face in the portrait image by a single-click of the mouse or a single-tap of the touchscreen, and select a one-click makeover by a single-click of the mouse or a single-tap of the touchscreen. The one-click makeover is a preprogrammed combination of feature enhancements including but not limited to the feature enhancements shown in the GUIs. The one-click makeover is applied to the selected face independently from other faces in the portrait image. Alternatively, the user can apply one or more feature enhancements independently. Feature enhancements include applying eyeliner, eye shadow, blush, lipstick, foundation, and other makeup, removing blemishes, oily shine, bags under the eyes, and dark circles around the eyes, slimming a face, lifting cheeks, enhancing a nose, and whitening teeth.

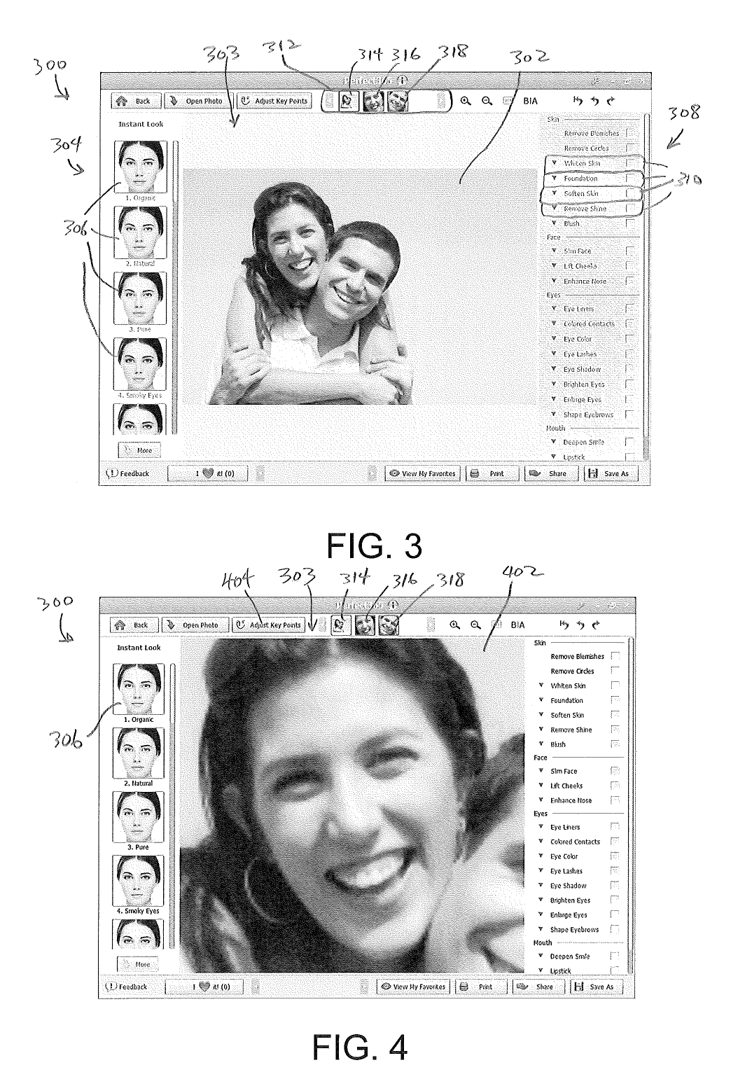

The user may select to save the new portrait image in a “favorites” folder. From the start of the makeover process, makeover application 120 may track the user activities, such as the selected one-click makeovers 306 (FIG. 3), the selected feature enhancements 310 (FIG. 3) and their attributes, and the order which the one-click makeovers and feature enhancements were applied. Makeover application 120 saves the user activities along with the corresponding portrait image in the favorites folder. Based on the saved user activities, makeover application 120 may recommend products that can be used to achieve the makeover effects. Makeover application 120 then generates a GUI with information on the recommended products (e.g., cosmetic or otherwise) located about the corresponding facial features on the portrait image so the user can learn about the recommended products, including how to use and where to buy the recommended products.

Makeover application 120 may initially provide a number of standard one-click makeovers and feature enhancements. A server computer 126 hosts a web marketplace or store on computer network 104 where the users of makeover application 120 can download additional one-click makeovers and feature enhancements for free or a fee. The one-click makeovers and the feature enhancements may be sold individually or provided as a subscription service where the users receive new effects each month. One-click makeovers and feature enhancements may come with advertisements that are displayed to the users, such as during the download of the effects or as banner ads within makeover application 120. Server computer 126 may also take submissions of one-click makeovers and feature enhancements from independent vendors to give to or sell to the users of makeover application 120.

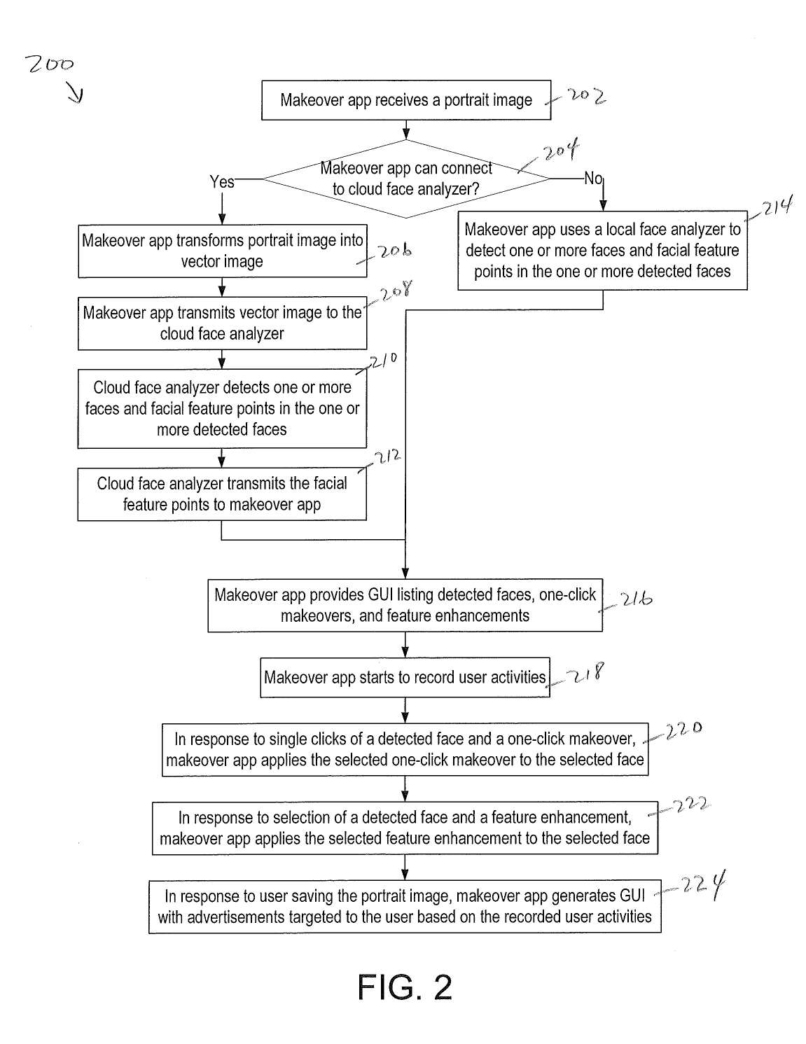

FIG. 2 is a flowchart of a method 200 for system 100 (FIG. 1) to improve a portrait image in one or more embodiments of the present disclosure. Method 200 may include one or more operations, functions, or actions illustrated by one or more blocks. Although the blocks are illustrated in sequential orders, these blocks may also be performed in parallel, and/or in a different order than those described herein. Also, the various blocks may be combined into fewer blocks, divided into additional blocks, and/or eliminated based upon the desired implementation. Method 200 may begin in block 202.

In block 202, makeover application 120 (FIG. 1) on computing device 102 (FIG. 1) receives a portrait image selected by the user. Makeover application 120 provides a file explorer for the user to select the portrait image. Block 202 may be followed by block 204.

In block 204, makeover application 120 determines if it can connect over computer network 104 (FIG. 1) to cloud face analyzer 122 (FIG. 1) on cloud server 106 (FIG. 1). If so, block 204 may be followed by block 206. Otherwise block 204 may be followed by block 214.

In block 206, makeover application 120 may transform the portrait image to a format of smaller size, such as vector graphics. Block 206 may be followed by block 208.

In block 208, makeover application 120 transmits the portrait image over computer network 104 to cloud face analyzer 122. Block 208 may be followed by block 210.

In block 210, cloud face analyzer 122 automatically detects one or more faces and their facial feature points on the vector image. Cloud face analyzer 122 may also detect age, gender, and/or race. Block 210 may be followed by block 212.

In block 212, cloud face analyzer 122 transmits the coordinates of the facial feature points over computer network 104 to makeover application 120. Cloud face analyzer 122 may also transmit the detected age, gender, and/or race to makeover application 120. Block 212 may be followed by block 216.

In block 214, when makeover application 120 determines it cannot connect to cloud face analyzer 122, the makeover application uses local face analyzer 124 to automatically detect one or more faces and their facial feature points on the portrait image. Local face analyzer 124 may also detect age, gender, and/or race. Block 214 may be followed by block 216.

In block 216, as shown in FIG. 3, makeover application 120 provides a GUI 300 displaying a selected portrait image 302 in a main viewing area 303 in one or more embodiments of the present disclosure. GUI 300 includes a scrollable list 304 of one-click makeovers 306 (less than all are labeled). As discussed above, one-click makeovers 306 is a preprogrammed combination of feature enhancements. GUI 300 includes a scrollable list 308 of feature enhancements 310 (less than all are labeled). Application 120 may filter the available one-click makeovers 306 and feature enhancements 310 by the detected age, gender, and/or race. GUI 300 includes a scrollable area 312 that displays an icon 314 for portrait image 302 and icons 316, 318 for each detected face. Referring back to FIG. 2, block 216 may be followed by block 218.

In block 218, makeover application 120 starts to record user activities, such as the selected one-click makeovers 306, the selected feature enhancements 310 and their attributes, and the order which the one-click makeovers and the feature enhancements were applied. As discussed above, the user activities may be later used to generate advertisements directed specifically at the user. Block 218 may be followed by block 220.

In block 220, as shown in FIG. 4, assume the user single-clicks or taps icon 316 for a detected face 402 in portrait image 302. Alternatively the user may single-click or tap face 402 in portrait image 302. In response, makeover application 120 displays the selected face 402 in main viewing area 303. Further assume the user single-clicks or taps a one-click makeover 306. In response, makeover application 120 applies the selected one-click makeover 306 to the selected face 402 and refreshes main viewing area 303 with the updated image. Note that makeover application 120 only applies the selected one-click makeover 306 to the selected face 402 and not to other faces in portrait image 302.

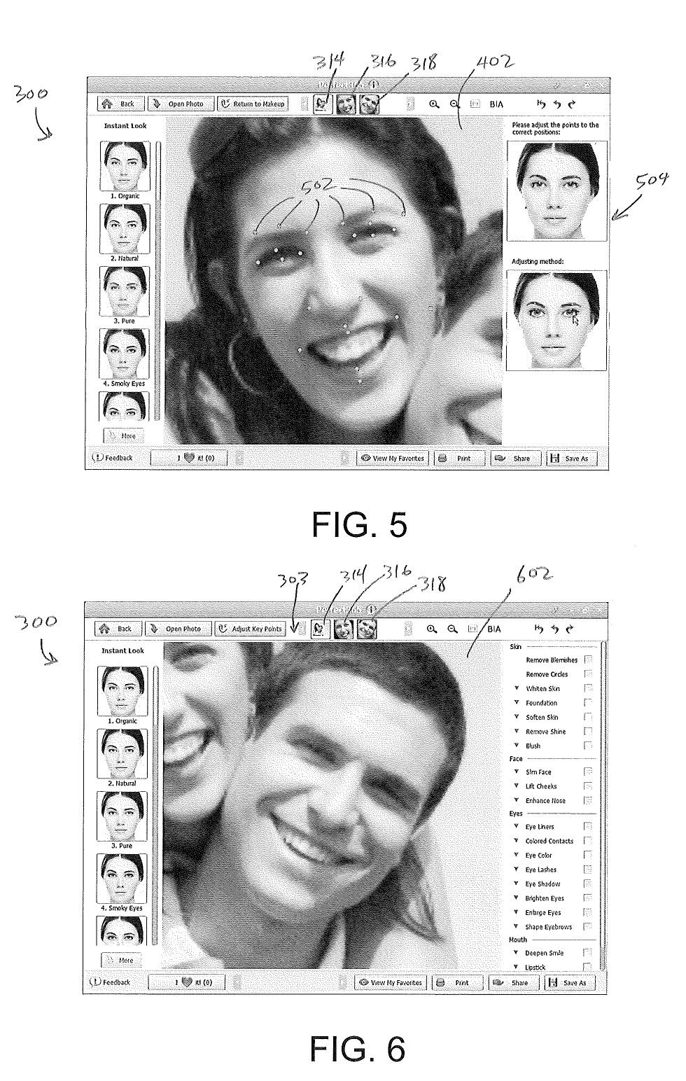

At any time, the user may select an “adjust key points” button 404 to adjust the locations of the facial feature points. As shown in FIG. 5, makeover application 120 displays the selected face 402 with feature points 502 (less than all are labeled). The user may drag the individual feature points 502 to desired locations following the illustrated instructions shown in a display area 504.

At any time, the user may single-click icon 314 to view the entire portrait image 302 or icon 318 to select a different detected face in the portrait image. Assume the user single-clicks or taps icon 318. As shown in FIG. 6, makeover application 120 displays a selected face 602 in main viewing area 303. As described above, the user may apply one-click makeovers or adjust the facial feature points of the selected face 602. Referring back to FIG. 2, block 220 may be followed by block 222.

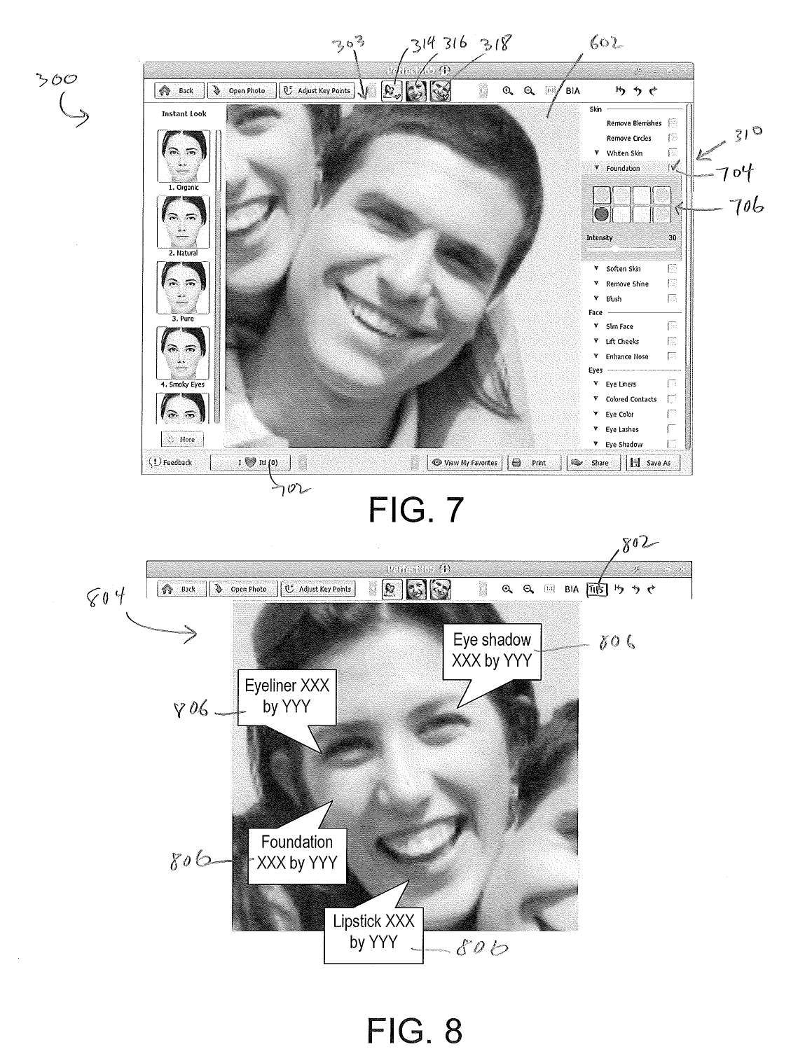

In block 222, as shown in FIG. 7, assume the user single-clicks or taps icon 318 for detected face 602 in portrait image 302. Alternatively the user may single-click or tap face 602 in portrait image 302. In response, makeover application 120 displays the selected face 602 in main viewing area 303. Further assume the user clicks or taps a check box 704 for feature enhancement 310. In response, makeover application 120 applies the selected feature enhancement 310 to the selected face 602 and refreshes main viewing area 303 with the updated image. Makeover application 120 may display additional options 706 for the selected feature enhancement 310. For example, when the user selects to apply a foundation to a face, the user can select the color of the foundation and an intensity of the foundation color.

Again, note that makeover application 120 only applies the selected feature enhancement 310 to the selected face 602 and not to other faces in portrait image 302. As described above, at any time the user may single-click icon 314 to view the entire portrait image 302 or icon 316 to select a different detected face in the portrait image to apply one-click makeovers/feature enhancements and adjust facial feature points.

The user may select a favorites button 702 to save portrait image 302 with the applied effects. As discussed above, makeover application 120 saves the recorded user activities along with portrait image 302 in a favorites folder. Referring back to FIG. 2, block 222 may be followed by block 224.

In block 224, as shown in FIG. 8, assume the user selects a “tips” button 802. In response, makeover application 120 generates a GUI 804 with message boxes 806 having tips on how to achieve the corresponding makeover effects. When the user selects a message box 806, additional information may be provided, such as how-to-instructions and videos, recommended products or services (e.g., beauty products and plastic surgeons), and where to obtain the recommended products or services (e.g., a link to a website or an address of a brick-and-mortal store selling the recommended products). As described, advertisements for products can be targeted at customers that may be most interested in those products and services. That is, application 120 may filter the available products and services by the detected age, gender, and/or race. GUI 300 includes a scrollable area 312 that displays an icon 314 for portrait image 302 and icons 316, 318 for each detected face.

Various other adaptations and combinations of features of the embodiments disclosed are within the scope of the present disclosure. For example, additional types of makeover in addition to a facial or makeup makeover may be provided. The additional categories of makeover include hair, eye glasses, clothes, jewelry, scarfs, clothes, purses, shoes, and accessories. When the user selects one of these additional categories, makeover application 120 may provide only makeover elements that are relevant to the age, gender, and race of a selected face or person in an image. Numerous embodiments are encompassed by the following claims.

What is claimed is:

1: A method for a makeover application executed by a processor, the method comprising:
when a cloud face analyzer is accessible over a computer network:
transmitting a copy of an image including a face to the cloud face analyzer over the computer network, wherein the cloud face analyzer detects the face and facial feature points of the face; and
receiving the facial feature points;
when the cloud face analyzer is not accessible over the computer network to, using a local face analyzer to detect the face and the facial feature points;
applying, using the processor, an effect to the face in the image based on the facial feature points;
displaying the image; and
saving the image.

2: The method of claim 1, further comprising, prior to applying the effect to the face:
receiving a first single-click or tap to select the face; and
receiving a second single-click or tap to select the effect.

3: The method of claim 2, wherein the effect comprises a one-click makeover and applying the effect to the face comprises applying multiple individual feature effects to the face.

4: The method of claim 2, wherein the effect comprises an individual feature effect.

5: The method of claim 2, wherein:
the image includes another face;
the cloud face analyzer or the local face analyzer detects the other face and other facial feature points of the other face; and
the effect is applied only to the face and not to the other face.

6: The method of claim 5, further comprising:
receiving a third single-click or tap to select the other face;
receiving a fourth single-click or tap to select another effect; and
applying the other effect only to the other face and not to the face.

7: The method of claim 1, wherein the copy of the image comprises vector graphics.

8: The method of claim 1, further comprising displaying a tip about the effect, the tip including information about a product or a service to achieve the effect.

9: The method of claim 8, wherein the product or the service is selected based on at least one of age and gender.

10: The method of claim 8, wherein the tip further information about where to purchase the product or the service.

11: The method of claim 1, further comprising displaying an advertisement.

12: The method of claim 1, further comprising:
downloading an additional effect from a server computer over the computer network; and
displaying an advertisement during downloading the additional effect.

13: A method for a makeover application executed by a processor, the method comprising:
generating a graphic user interface to select:
individual faces in an image; and
effects;
receiving a first single-click or tap to select a face in the image;
receiving a second single-click or tap to select an effect;
applying, using the processor, the selected effect only to the selected face;
displaying the image; and
saving the image.

14: The method of claim 13, further comprising:
when a cloud face analyzer is accessible over a computer network:
transmitting a copy of the image to the cloud face analyzer over the computer network, wherein the cloud face analyzer automatically detects the faces in the image and sets of facial feature points of the faces; and
receiving the sets of facial feature points; and
when the cloud face analyzer is not accessible over the computer network to, using a local face analyzer to automatically detect the faces and the sets of facial feature points.

15: The method of claim 13, wherein the effect comprises a one-click makeover and applying the effect to the face comprises applying multiple individual feature effects to the selected face.

16: The method of claim 13, wherein the effect comprises an individual feature effect.

17: The method of claim 13, further comprising displaying a tip about the effect, the tip including information about where to purchase a product or a service to achieve the effect.

18: The method of claim 17, wherein the product or the service is selected based on at least one of age, gender, and race.

19: The method of claim 13, further comprising displaying an advertisement.

20: The method of claim 13, further comprising:
downloading an additional effect from a server computer over the computer network; and
displaying an advertisement during downloading the additional effect.
